(19) United States
(12) Patent Application Publication
(10) Pub. No.: US 2025/0151088 A1
(43) Pub. Date: May 8, 2025

(54) SIDELINK RESOURCE SELECTION FOR A USER EQUIPMENT (UE)

(71) Applicant: QUALCOMM Incorporated, San Diego, CA (US)

(72) Inventors: Chunxia Li, Beijing (CN); Matthew Heng Zhang, Shanghai (CN); Rajat Kapur, San Diego, CA (US); Yuyu Yan, Beijing (CN); Liang Zhu, Shanghai (CN); Hua Xu, Shanghai (CN); Feng Chen, Beijing (CN); Ankit Gothi, San Diego, CA (US)

(21) Appl. No.: 18/838,186

(22) PCT Filed: Apr. 28, 2022
(86) PCT No.: PCT/CN2022/089910

§ 371 Date: Aug. 13, 2024

(51) Int. Cl. H04W 72/25; H04L 5/00

(52) U.S. Cl. CPC H04W 72/25; H04L 5/0048

(57) ABSTRACT

An apparatus includes a receiver configured to receive, from a base station, a control message indicating a sidelink resource pool. The apparatus further includes a transmitter configured to perform, after receiving the control message, a sidelink transmission using one or more sidelink resources. Based on a speed exceeding a threshold speed, the one or more sidelink resources include one of a first sidelink resource of the sidelink resource pool or a preconfigured sidelink resource. The one or more sidelink resources include the first sidelink resource based on the first sidelink resource being associated with a high speed flag. The one or more sidelink resources include the preconfigured sidelink resource based on a time interval since a previous sidelink transmission failing to exceed a threshold time interval and further based on the sidelink resource pool failing to indicate a resource associated with the high speed flag.

### TECHNICAL FIELD

Aspects of the present disclosure relate generally to wireless communication systems, and more particularly, to wireless communication systems, and more particularly, to wireless communication systems that perform sidelink communications.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

Some types of wireless communication networks may support sidelink communications between UEs. For example, one UE may transmit a message to another UE via a sidelink. As an illustrative example, a vehicle may communicate with another vehicle using a vehicle-to-everything (V2X) wireless communication protocol, which may enable the vehicles to communicate information related to traffic, emergencies, and other information.

In some wireless communication protocols, the UEs may perform sidelink communications using sidelink resources of a sidelink resource pool indicated by a base station. In some circumstances, a UE may need to reconfigure the sidelink resources (e.g., by selecting other sidelink resources in order to reduce or avoid interference or collisions with other signals). Reconfiguring sidelink resources may involve modifying operation of a transmitter of the UE (such as by changing transmit frequencies of the transmitter), which may increase power consumption of the UE. Further, during sidelink resource reconfiguration, a UE may be unable to transmit data, to receive data, or both, which may incur latency or data loss.

### BRIEF SUMMARY OF SOME EXAMPLES

In one aspect of the disclosure, an apparatus for wireless communication by a user equipment (UE) includes a receiver configured to receive, from a base station, a control message indicating a sidelink resource pool. The apparatus further includes a transmitter configured to perform, after receiving the control message, a sidelink transmission using one or more sidelink resources. Based on a speed associated with the UE exceeding a threshold speed, the one or more sidelink resources include one of a first sidelink resource of the sidelink resource pool or a preconfigured sidelink resource. The one or more sidelink resources include the first sidelink resource based on the first sidelink resource being associated with a high speed flag. The one or more sidelink resources include the preconfigured sidelink resource based on a time interval since a previous sidelink transmission failing to exceed a threshold time interval and further based on the sidelink resource pool failing to indicate a resource associated with the high speed flag.

In another aspect, a method of wireless communication performed by a UE includes receiving, from a base station, a control message indicating a sidelink resource pool. The method further includes, after receiving the control message, performing a sidelink transmission using one or more sidelink resources. Based on a speed associated with the UE exceeding a threshold speed, the one or more sidelink resources include one of a first sidelink resource of the sidelink resource pool or a preconfigured sidelink resource. The one or more sidelink resources include the first sidelink resource based on the first sidelink resource being associated with a high speed flag. The one or more sidelink resources include the preconfigured sidelink resource based on a time interval since a previous sidelink transmission failing to exceed a threshold time interval and further based on the sidelink resource pool failing to indicate a resource associated with the high speed flag.

In another aspect, a non-transitory computer-readable medium stores instructions executable by a processor to initiate, perform, or control operations of a UE. The operations include receiving, from a base station, a control message indicating a sidelink resource pool. The operations further include, after receiving the control message, performing a sidelink transmission using one or more sidelink resources. Based on a speed associated with the UE exceeding a threshold speed, the one or more sidelink resources include one of a first sidelink resource of the sidelink resource pool or a preconfigured sidelink resource. The one or more sidelink resources include the first sidelink resource based on the first sidelink resource being associated with a high speed flag. The one or more sidelink resources include the preconfigured sidelink resource based on a time interval since a previous sidelink transmission failing to exceed a threshold time interval and further based on the sidelink resource pool failing to indicate a resource associated with the high speed flag.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a block diagram illustrating details of an example wireless communication system according to some aspects of the disclosure.

FIG. 2 is a block diagram illustrating examples of a base station and a user equipment (UE) according to some aspects of the disclosure.

FIG. 3 is a diagram illustrating examples of operations that may be performed in connection with a wireless communication network according to some aspects of the disclosure.

FIG. 4A is a block diagram illustrating an example wireless communication system according to some aspects of the disclosure.

FIG. 4B is a block diagram illustrating an example of a sidelink resource pool according to some aspects of the disclosure.

FIG. 5 is a flow diagram illustrating an example of a method of wireless communication performed by a UE according to some aspects of the disclosure.

FIG. 6 is a flow diagram illustrating another example of a method of wireless communication performed by a UE according to some aspects of the disclosure.

FIG. 7 is a block diagram of an example UE according to one or more aspects.

Like reference numbers and designations in the various drawings may indicate like elements.

### DETAILED DESCRIPTION

A user equipment (UE) according to some aspects of the disclosure may perform one or more operations that may enable the UE to avoid one or more instances of sidelink resource pool reconfiguration. To illustrate, after configuring sidelink communications via a sidelink resource pool associated with a base station, the UE may enter a high-speed mode of operation (e.g., where a speed or velocity associated with the UE is greater than a threshold speed or velocity). In some cases, the UE may perform one or more operations that may enable the UE to avoid reconfiguring sidelink resources. The UE may “ignore” resources of the sidelink resource pool in some cases.

For example, the UE may check whether a “high speed” flag is enabled. The high speed flag may indicate availability of a frequency associated with a high speed mode. In some examples, the high speed flag may be indicated in a system information block (SIB). If the high speed flag is enabled for a particular frequency, the UE may prioritize or use the frequency for a sidelink communication (e.g., instead of performing sidelink resource pool reconfiguration).

To illustrate, in some cases, use of a frequency associated with a high speed flag may reduce or avoid frequent sidelink resource pool selection that can increase power consumption of the UE. For example, the radius (or range) of a signal transmitted using a frequency associated with the high speed flag may be larger as compared to other frequencies that are not associated with a high speed flag. In this case, the frequency associated with the high speed flag may be used by the UE over a greater area as compared to the other frequencies. As a result, use of the frequency may reduce the rate of sidelink resource pool selection, which may reduce power consumption of the UE and may support continuous sidelink communications during a high speed mode of operation of the UE.

In some other cases, the sidelink resource pool may not include any frequency associated with a high speed flag. In such examples, the UE may determine whether sidelink pool resources are frequently changing (or subject to frequent change). If the sidelink pool resources are frequently changing (or subject to frequent change), the UE may use a preconfigured sidelink resource for a sidelink communication (e.g., instead of performing sidelink resource pool reconfiguration).

To illustrate, in some implementations, the UE may use a time interval to determine whether to perform sidelink resource pool reconfiguration, such as a time interval that represents a “minimum” amount of time between sidelink resource pool reconfigurations. In such examples, if the UE has performed a prior sidelink resource pool reconfiguration within the time interval, the UE may use a preconfigured sidelink resource for a sidelink communication (e.g., instead of performing sidelink resource pool reconfiguration). In some other examples, if the UE has not performed a prior sidelink resource pool reconfiguration within the time interval, the UE may perform (or allow) sidelink resource pool reconfiguration.

In some other cases, if no frequency associated with a high flag is available, and if the sidelink pool resources are not frequently changing, the UE may perform one or more other operations. For example, the UE may perform sidelink resource pool reconfiguration, such as by reselecting among sidelink resources indicated by the sidelink resource pool. Accordingly, in some examples, the UE may select resources for a sidelink communication based on a priority scheme. The priority scheme may assign a first priority (e.g., a highest priority) to a frequency associated with a high speed flag, a second priority (e.g., a middle priority) to preconfigured sidelink resources, and a third priority (e.g., a lowest priority) to resources associated with sidelink resource pool reconfiguration.

By reducing or avoiding one or more instances of sidelink resource pool reconfiguration, performance of a UE may be enhanced. For example, by reducing or avoiding sidelink resource pool reconfiguration, the UE may reduce power consumption associated with sidelink resource pool reconfiguration. Further, the UE may avoid data loss or latency that may occur due to inability of the UE to receive data, to transmit data, or both, during sidelink resource pool reconfiguration.

To further illustrate, one or more aspects described herein may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km\hat{ }2), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km\hat{ }2), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs may enable transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

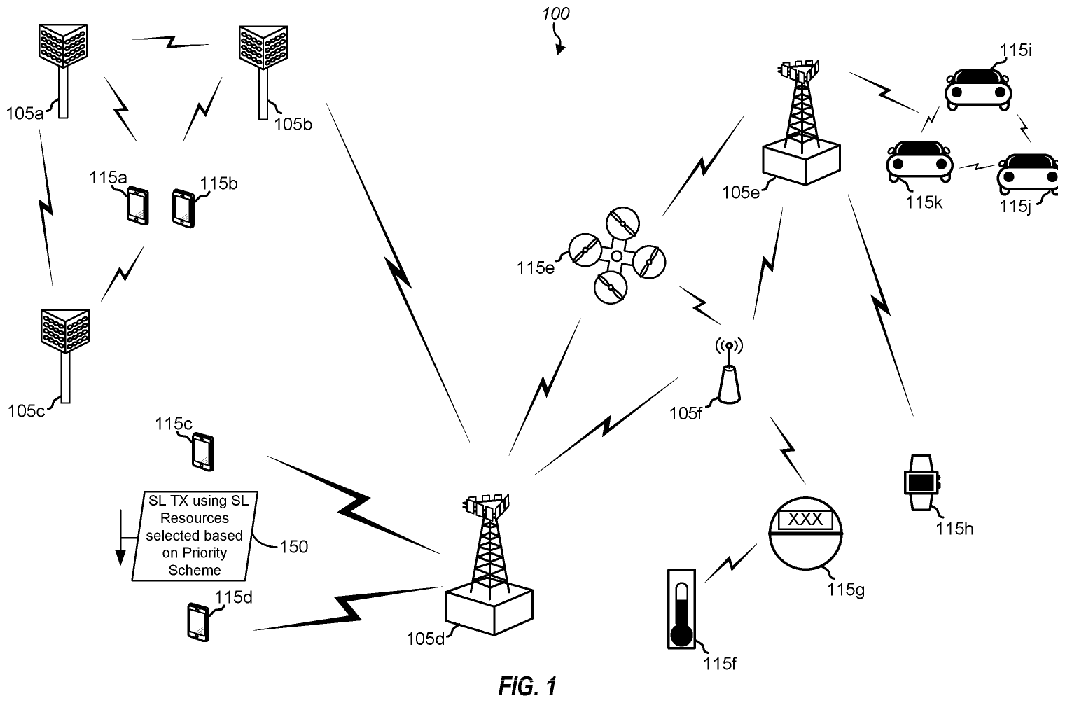

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water infrastructure, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such as UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

In some examples, one or more UEs 115 of FIG. 1 may perform sidelink communications. For example, FIG. 1, illustrates an example in which the UE 115c may perform a sidelink transmission (SL TX) 150 to the UE 115d. The UE 115c may perform the sidelink transmission 150 using sidelink resources selected based on a priority scheme, as described further below.

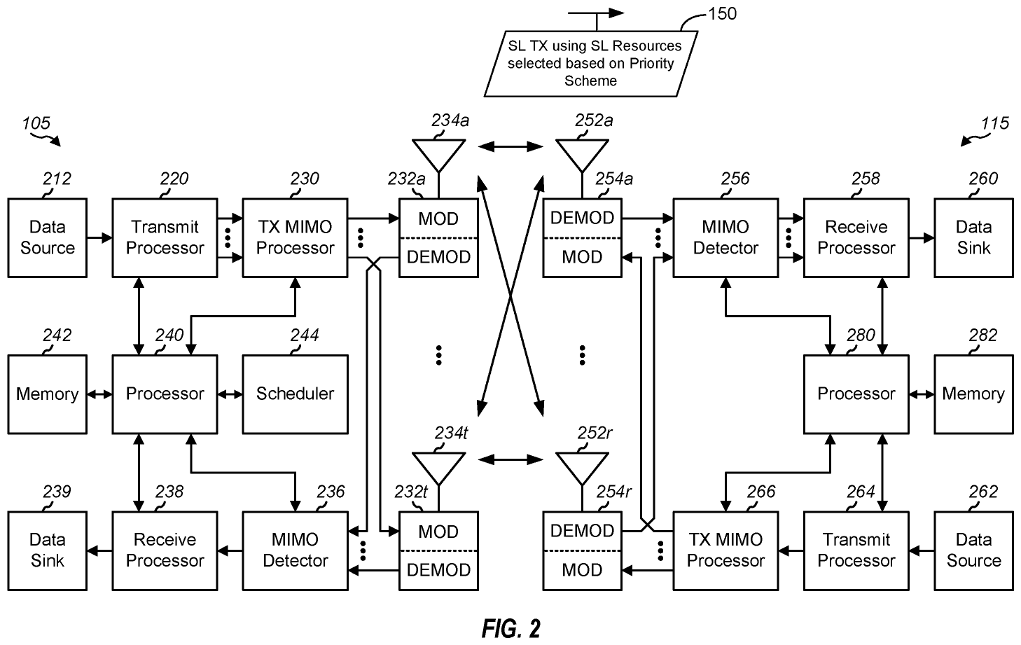

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from processor 240. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234tk, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to processor 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from processor 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to processor 240.

Processors 240 and 280 may direct the operation at base station 105 and UE 115, respectively. Processor 240 or other processors and modules at base station 105 or processor 280 or other processors and modules at UE 115 may perform or direct the execution of various processes for one or more operations described herein, such as to perform or direct the transmission of the sidelink transmission 150 to another UE 115, to perform one or more other operations, or a combination thereof. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

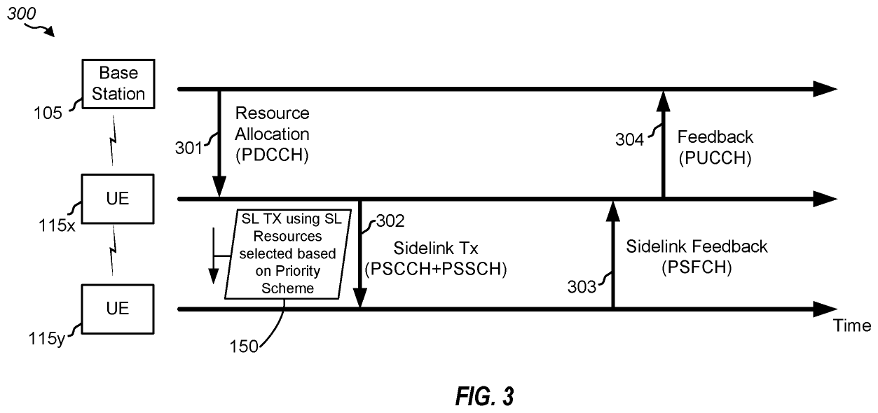

FIG. 3 is a diagram illustrating examples of operations 300 that may be performed in connection with a wireless communication network according to some aspects of the disclosure. The operations 300 may be described with reference to a first UE 115x (e.g., one of the UEs 115a-k of FIG. 1, or another UE), a second UE 115y (e.g., another of the UEs 115a-k of FIG. 1, or another UE), and the base station 105. In some other examples, the operations 300 may be performed with respect to other UEs and other UE configurations.

The operations 300 may illustrate an example of a first mode of operation (Mode 1) in which resource allocation of Tx resources for sidelink communications is performed, at 301, by the base station 105. The first mode (Mode 1) may support dedicated grants (DGs) and configured grants (CGs) of type 1 and may further supported CGs of type 2. A CG of type 1 may be activated via RRC signaling from the base station 105. A modulation and coding scheme (MCS) may be determined by a transmitting UE, such as the first UE 115x, within parameters set by the base station 105 (such as parameters indicated by the DCI). In some other aspects of the disclosure, one or more other operations described herein may be performed using one or more other modes of operation, such as a second mode of operation (Mode 2).

At 302, the first UE 115x may perform a sidelink transmission (such as by transmitting sidelink control information (SCI), data, or a combination thereof) to the second UE 115y via the sidelink. The sidelink may include a physical sidelink control channel (PSCCH), a physical sidelink shared channel (PSSCH), a physical sidelink feedback channel (PSFCH), one or more other channels, or a combination thereof. In some aspects, performing the sidelink transmission may include performing the sidelink transmission 150. In some examples, the first UE 115x may perform the sidelink transmission 302 using sidelink resources not included in the resource allocation indicated by the base station 105 (at 301). For example, in some cases, the first UE 115x may “ignore” the resource allocation indicated by the base station 105, as described further below.

At 303, the second UE 115y may transmit sidelink feedback to the first UE 115x via the sidelink (e.g., via the PSFCH), such as an acknowledgement (ACK) or a negative-acknowledgement (NACK). At 304, the first UE 115x may forward the sidelink feedback to the base station 105 (e.g., using a PUCCH). The base station 105 may perform one or more operations based on the sidelink feedback, such as resource allocation, as an illustrative example.

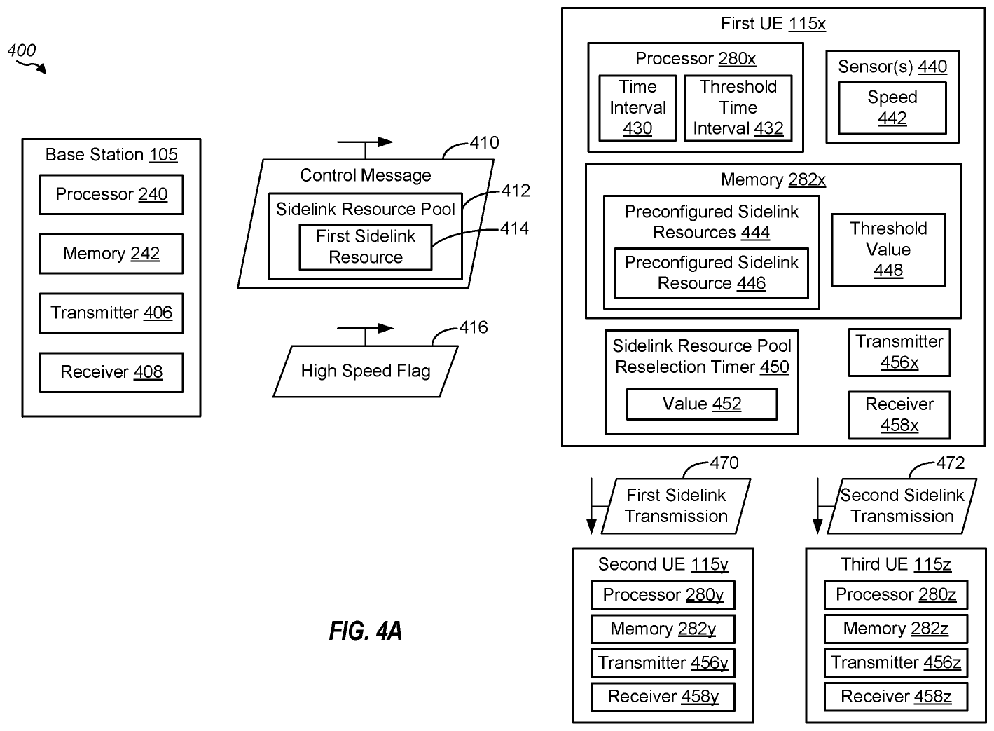

FIG. 4A is a block diagram illustrating an example of a wireless communication system 400 according to some aspects of the disclosure. The wireless communication system 400 may include one or more base stations, such as the base station 105. The wireless communication system 400 may include one or more UEs, such as the first UE 115x, the second UE 115y, and a third UE 115z.

The base station 105 may include one or more processors (such as the processor 240) and may include one or more memories (such as the memory 242). For example, the base station 105 may include a processor 240 and a memory 242. The base station 105 may include a transmitter 406 and a receiver 408. The processor 240 may be coupled to the memory 242, to the transmitter 406, and to the receiver 408. In some examples, the transmitter 406 and the receiver 408 may include one or more components described with reference to FIG. 2, such as one or more of the modulator/demodulators 232a-t, the MIMO detector 236, the receive processor 238, the transmit processor 220, or the TX MIMO processor 230. In some implementations, the transmitter 406 and the receiver 408 may be integrated in one or more transceivers of the base station 105.

The transmitter 406 may be configured to transmit reference signals, synchronization signals, control information, and data to one or more other devices, and the receiver 408 may be configured to receive reference signals, control information, and data from one or more other devices. For example, the transmitter 406 may be configured to transmit signaling, control information, and data to the UEs 115x-y, and the receiver 408 may be configured to receive signaling, control information, and data from the UEs 115x-y.

The UEs 115x-ymay each include one or more processors (such as a processors 280x, 280y, and 280z), a memory (such as memories 282x, 282y, and 282z)), a transmitter (such as a transmitters 456x, 456y, and 456z), and a receiver (such as a receivers 458x, 458y, and 458z). The processor 280x may be coupled to the memory 282x, to the transmitter 456x, and to the receiver 458x. The processor 280y may be coupled to the memory 282y, to the transmitter 456y, and to the receiver 458y. The processor 280z may be coupled to the memory 282z, to the transmitter 456z, and to the receiver 458z. In some examples, the transmitters 456x-z and the receivers 458x-z may each include one or more components described with reference to FIG. 2, such as one or more of the modulator/demodulators 254a-r, the MIMO detector 256, the receive processor 258, the transmit processor 264, or the TX MIMO processor 266. In some implementations, the transmitter 456x and the receiver 458x may be integrated in one or more transceivers of the first UE 115x, the transmitter 456y and the receiver 458y may be integrated in one or more transceivers of the second UE 115y, and the transmitter 456z and the receiver 458z may be integrated in one or more transceivers of the third UE 115z.

Each transmitter 456x-z may be configured to transmit reference signals, synchronization signals, control information, and data to one or more other devices, and each receiver 458x-z may be configured to receive reference signals, control information, and data from one or more other devices. For example, the transmitter 456x may be configured to transmit signaling, control information, and data to the base station 105, the second UE 115y, and the third UE 115z. The receiver 458x may be configured to receive signaling, control information, and data from the base station 105, the second UE 115y, and the third UE 115z. To further illustrate, the transmitter 456y may be configured to transmit signaling, control information, and data to the base station 105, the first UE 115x, and the third UE 115z. The receiver 458y may be configured to receive signaling, control information, and data from the base station 105, the first UE 115x, and the third UE 115z.

In some implementations, one or more of the transmitter 456x, the transmitter 456y, the transmitter 456z, the receiver 458x, the receiver 458y, or the receiver 458z may include an antenna array. The antenna array may include multiple antenna elements that perform wireless communications with other devices. In some implementations, the antenna array may perform wireless communications using different beams, also referred to as antenna beams. The beams may include transmit beams and receive beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. In some implementations, one or more sets of antenna elements of the antenna array may be configured to concurrently generate multiple beams, for example using multiple RF chains. A set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some examples, the first UE 115x may include a timer, such as a sidelink resource pool reselection timer 450 (e.g., a software timer or a hardware timer). The first UE 115x may include one or more sensors 440. The one or more sensors 440 may include a Doppler-based sensor, a global positioning system (GPS) receiver, an accelerometer, another sensor, or a combination thereof.

In some implementations, the wireless communication system 400 operates in accordance with one or more of a 4G LTE network or a 5G NR network. For example, the wireless communication system 400 may include multiple 5G-capable UEs 115 and multiple 5G-capable base stations 105, such as UEs and base stations configured to operate in accordance with a 5G NR network protocol (such as the 5G NR network protocol defined by the 3GPP).

During operation, the UEs 115x-z may monitor for messages from base stations, such as the base station 105. For example, the first UE 115x may receive a control message 410 from the base station 105. In some examples, the control message 410 may correspond to or include a system information block (SIB). Examples of SIBs may include a SIB of type 1 (SIB1), a SIB of type 2 (SIB2), or a SIB of type 21 (SIB21). In some other examples, the control message 410 may correspond to or include another message, such as a radio resource control (RRC) reconfiguration message. In some examples, the control message 410 may include the resource allocation described with reference to FIG. 3 (at 301).

The control message 410 may indicate a sidelink resource pool 412. For example, the sidelink resource pool 412 may include sidelink resources (such as a first sidelink resource 414) available for sidelink communications between UEs, such as the UEs 115x-y. In some examples, the first UE 115x may perform a first sidelink transmission 470 to the second UE 115y based on one or more sidelink resources of the sidelink resource pool 412, such as the first sidelink resource 414. In some examples, the first sidelink transmission 470 may correspond to the sidelink transmission 150 of FIGS. 1-3.

To further illustrate, the first sidelink transmission 470 may include a vehicle-to-everything (V2X) communication performed by the first UE 115x based on a V2X wireless communication protocol. In some examples, the first sidelink transmission 470 may include position information associated with the first UE 115x, velocity information associated with the first UE 115x, acceleration information associated with the first UE 115x, information indicating a maneuver to be performed by the first UE 115x (such as a lane change or a turn), traffic information, emergency information (such as information indicating an accident detected by the first UE 115x), or a combination thereof.

In some circumstances, the first UE 115x may change locations relatively frequently, such as if the first UE 115x corresponds to a vehicle or if the first UE 115x is carried by a user on a vehicle, such as a car, train, or other vehicle. In some such examples, the first UE 115x may change, reselect, or reconfigure sidelink resources, such as by reselecting among sidelink resources of the sidelink resource pool 412.

Reselecting sidelink resources for sidelink communications may reduce performance or may increase power consumption in the wireless communication system 400. For example, reselecting sidelink resources may involve changing transmit frequencies of the transmitter 456y, which may increase power consumption. Further, in some implementations, reselecting sidelink resources may disrupt communications, such as by prevent or delaying transmission or reception of data, which may incur latency or data loss.

In some aspects of the disclosure, the first UE 115x may determine whether to perform sidelink resource reselection based at least in part on detecting a speed 442 associated with the first UE 115x (e.g., via the one or more sensors 440) that exceeds a threshold speed. In such examples, the speed 442 may correspond to or may be associated with a high speed mode of the first UE 115x.

Based on detecting the speed 442, the first UE 115x may determine whether the sidelink resource pool 412 includes one or more resources (e.g., a frequency) associated with a particular flag (e.g., a speed-based flag), such as a high speed flag 416. A resource associated with the high speed flag 416 may be used by devices in a high speed mode. The first UE 115x may use or prioritize such resources for the second sidelink transmission 472.

To illustrate, in some examples, a base station (such as the base station 105) may transmit an indication of the high speed flag 416. In some examples, the control message 410 may indicate the high speed flag 416. In some other messages, the base station 105 may transmit the high speed flag 416 separately from the control message 410. In some examples, the high speed flag 416 may be included in a SIB, such as in a SIB1 (e.g., in connection with an NR wireless communication protocol), in a SIB2 (e.g., in connection with an LTE wireless communication protocol), or in a SIB 21. In some other examples, the high speed flag 416 may be included in another message.

In some examples, based on the high speed flag 416 being asserted for a resource, the first UE 115x may prioritize the resource for a sidelink transmission. For example, if the high speed flag 416 is asserted for the first sidelink resource 414, then the first UE 115x may use the first sidelink resource 414 to perform the second sidelink transmission 472.

To further illustrate, FIG. 4B illustrates an example of the sidelink resource pool 412 according to some aspects of the disclosure. In the example of FIG. 4B, the high speed flag 416 may be asserted for the first sidelink resource 414, which may correspond to a first frequency (F1). In such examples, the first UE 115x may determine a first priority 492 associated with the first sidelink resource 414 (e.g., a high priority). In the example of FIG. 4B, the high speed flag 416 may not be asserted for other resources of the sidelink resource pool 412 (such as a second frequency (F2) and a third frequency (F3)). In some examples, the first frequency F1 may correspond to a carrier frequency that is less than carrier frequencies corresponding to the second frequency F2 and the third frequency F2. In some implementations, a signal transmitted based on the first frequency F1 may be associated with a greater radius (or range) than a signal transmitted based on the second frequency F2 or the third frequency F3, which may enable the first UE 115x to reduce or avoid sidelink resource reselection in some cases.

In some other examples, if the high speed flag 416 may not be asserted for any resources of the sidelink resource pool 412. In such examples, the first UE 115x may perform the second sidelink transmission 472 using another technique, such as based on preconfigured sidelink resources 444, or based on sidelink resource pool reselection to other resources of the sidelink resource pool 412 (e.g., resources not associated with the high speed flag 416).

To illustrate, based on determining that the high speed flag is not asserted for any resources of the sidelink resource pool 412 (e.g., where the base station 105 does not support the high speed mode), the first UE 115x may determine whether a time interval 430 exceeds a threshold time interval 432. To illustrate, the threshold time interval 432 may correspond to a minimum time (such as a threshold number of milliseconds (ms)) between sidelink resource pool reselection. For example, prior to expiration of the time interval 430, the first UE 115x may avoid performing sidelink resource pool reselection, such as by using a preconfigured sidelink resource 446 of preconfigured sidelink resources 444 to perform the second sidelink transmission 472. In some other examples, after expiration of the expiration of the time interval 430, the first UE 115x may perform (or may allow) sidelink resource pool reselection.

In some examples, the preconfigured sidelink resources 444 may be specified by a wireless network, such as an LTE wireless network or an NR wireless network. In some examples, the preconfigured sidelink resources 444 may be associated with or defined in a data service layer associated with the first UE 115x and may be stored in data service memory associated with the first UE 115x. In some examples, the preconfigured sidelink resources 444 may not be specific to a particular base station 105. For example, the preconfigured sidelink resources 444 may be configured for use within an area that exceeds a coverage area of the base station 105. The area may correspond to a large geographic region, such as a country or another large geographic region. In some examples, the first UE 115x may be configured with the preconfigured sidelink resources 444 prior to communicating with the base station 105 (e.g., prior to receiving the control message 410).

In some examples, the first UE 115x may use the sidelink resource pool reselection timer 450 to determine whether the time interval 430 is expired. For example, the processor 280x may reset operation of the sidelink resource pool reselection timer 450 based on a first event. In some examples, the first event may correspond to or include receiving the control message 410, configuring the transmitter 456x based on the sidelink resource pool 412 (e.g., by configuring the transmitter 456x to transmit using a frequency associated with the first sidelink resource 414), performing the first sidelink transmission 470, or performing sidelink resource pool reselection. In some examples, resetting operation of the sidelink resource pool reselection timer 450 may include resetting a value 452 of the sidelink resource pool reselection timer 450 (e.g., to zero or another value).

After resetting operation of the sidelink resource pool reselection timer 450, the sidelink resource pool reselection timer 450 may count to a threshold value 448 (e.g., by incrementing or decrementing the value 452 of the sidelink resource pool reselection timer 450). The threshold value 448 may correspond to the threshold time interval 432. In some examples, the first UE 115x may detect expiration of the time interval 430 based on detecting that the value 452 of the sidelink resource pool reselection timer 450 satisfies (e.g., exceeds) the threshold value 448. In some other examples, the first UE 115x may determine that the time interval 430 is unexpired based on detecting that the value 452 of the sidelink resource pool reselection timer 450 fails to exceed the threshold value 448.

To further illustrate, the processor 280x may query the sidelink resource pool reselection timer 450 to identify the value 452 based on detecting a second event. In some examples, the second event includes or corresponds to determining that data (or another message) is to be transmitted via a sidelink transmission, such as the first sidelink transmission 470 or the second sidelink transmission 472. After identifying the value 452, the processor 280x may compare the value 452 to the threshold value 448 to determine whether the time interval 430 is expired.

In some examples, the threshold time interval 432 may be selected dynamically. For example, the threshold time interval 432 may be selected or adjusted via a software update (e.g., a firmware update) of the first UE 115x, via an over-the-air (OTA) network settings update by a network operator associated with the wireless communications system 400, or via another technique, as illustrative examples. In some examples, use of the threshold time interval 432 may be dynamically enabled or disabled, such as by disabling use of the threshold time interval 432 if the first UE 115x is or is expected to be relatively stationary (e.g., in a parked mode of a vehicle, as an illustrative example).

In some implementations, the first UE 115x may selectively access the sidelink resource pool reselection timer 450 based on detecting the speed 442 associated with the first UE 115x. For example, if the first UE 115x fails to detect the speed 442 exceeding a threshold speed, then the first UE 115x may continue to use a sidelink resource pool for sidelink transmissions, such as by using the sidelink resource pool 412 for the second sidelink transmission 472 (e.g., irrespective of whether the time interval 430 is expired). In some such examples, the first UE 115x may perform sidelink resource pool reselection irrespective of the value 452. In some other examples, if the first UE 115x detects the speed 442 exceeding the threshold speed, then the first UE 115x may determine whether the time interval 430 is expired and may perform the second sidelink transmission 472 based on whether the time interval 430 is expired.

In some circumstances, the first UE 115x may determine that the high speed flag is not asserted for any resource of the sidelink resource pool 412 and may further determine that the time interval 430 exceeds the threshold time interval 432. In this case, the first UE 115x may perform sidelink resource pool reselection. For example, the first UE 115x may perform sidelink resource pool reselection to other resources of the sidelink resource pool 412, such as by selecting one or more resources of the sidelink resource pool 412 not associated with the high speed flag 416.

Accordingly, in some examples, the first UE 115x may select one or more sidelink resources for a sidelink transmission based on a priority scheme. The priority scheme may indicate that a resource associated with the high speed flag 416 (e.g., the first sidelink resource 414 in the example of FIG. 4B) may be associated with a first priority (e.g., the first priority 492 of FIG. 4B) for the sidelink transmission and that the preconfigured sidelink resources 444 (e.g., the preconfigured sidelink resource 446) is associated with a second priority less than the first priority. The priority scheme may also indicate that a second sidelink resource of the sidelink resource pool 412 not associated with the high speed flag 416 (e.g., the frequencies F2, F3 in the example of FIG. 4B) is associated with a third priority less than the second priority.

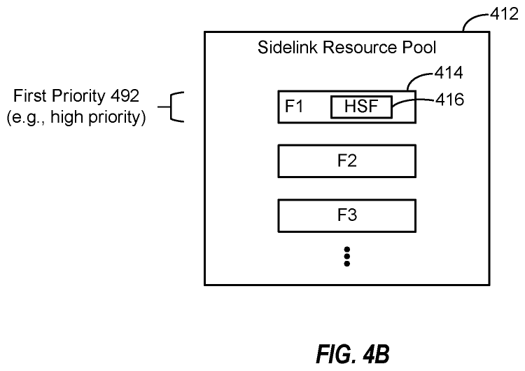

To further illustrate, FIG. 5 is a flow chart illustrating an example of a method 500 of wireless communication according to some aspects of the disclosure. In some examples, the method 500 may be performed by a UE, such as by the first UE 115x of FIG. 4A. It is noted that the example of FIG. 5 is illustrated and other examples (e.g., other orders of operations) are also within the scope of the disclosure.

The method 500 may include receiving, at a UE, a control message indicating a sidelink resource pool, at 502. For example, the first UE 115x may receive the control message 410 from the base station 105, and the control message 410 may indicate the sidelink resource pool 412.

The method 500 may further include resetting operation of a timer of the UE, at 504. For example, the first UE 115x may reset operation of the sidelink resource pool reselection timer 450, such as by resetting the value 452 of the sidelink resource pool reselection timer 450 and by initiating counting of the sidelink resource pool reselection timer 450.

The method 500 may further include detecting that a speed associated with the UE exceeds a threshold speed, at 506. For example, in some implementations, the first UE 115x may detect the speed 442, which may include or correspond to entering a high speed mode of the first UE 115x.

The method 500 may further include determining that data is to be transmitted via a sidelink transmission, at 508. For example, in an illustrative example of a V2X communication, the data may include one or more of position information associated with the first UE 115x, velocity information associated with the first UE 115x, acceleration information associated with the first UE 115x, information indicating a maneuver to be performed by the first UE 115x (such as a lane change or a turn), traffic information, or emergency information (such as information indicating an accident detected by the first UE 115x), as illustrative examples.

The method 500 may further include determining whether a high speed flag is asserted, at 510. For example, the first UE 115x may determine whether the first UE 115x has received the high speed flag 416 indicating that the high speed flag 416 is asserted.

If the high speed flag is asserted, the method 500 may further include selecting one or more resources associated with the high speed flag, at 512. For example, the first UE 115x may select one or more “high speed” frequencies associated with a high speed mode corresponding to the high speed flag 416, such as the first sidelink resource 414 (e.g., the first frequency F1 of FIG. 4B).

If the high speed flag is non-asserted, the method 500 may further include determining whether the timer is expired, at 514. For example, the first UE 115x may access the sidelink resource pool reselection timer 450 to identify the value 452 indicated by the sidelink resource pool reselection timer 450. The first UE 115x may compare the value 452 indicated by the sidelink resource pool reselection timer 450 to the threshold value 448 to determine whether the sidelink resource pool reselection timer 450 is expired. For example, if the value 452 indicated by the sidelink resource pool reselection timer 450 exceeds the threshold value 448, the first UE 115x may determine that the sidelink resource pool reselection timer 450 is expired. In some other examples, if the value 452 indicated by the sidelink resource pool reselection timer 450 fails to exceed the threshold value 448, the first UE 115x may determine that the sidelink resource pool reselection timer 450 is unexpired.

If the timer is unexpired, the method 500 may further include selecting one or more resources from preconfigured sidelink resources associated with the UE, at 516. For example, the first UE 115x may select the preconfigured sidelink resource 446.

If the timer is expired, the method 500 may further include performing sidelink resource reselection to reselect one or more resources of a second sidelink resource pool, at 518. For example, the first UE 115x may reselect one or more resources of the sidelink resource pool 412 that are not associated with the high speed flag 416.

The method 500 may further include performing a sidelink transmission based on the selected one or more resources, at 520. For example, the first UE 115x may perform the first sidelink transmission 470 or the second sidelink transmission 472 based on the selected one or more resources.

To further illustrate, in some examples, the processor 280x of FIG. 4A may be configured to select, for the second sidelink transmission 472, from among resources associated with the high speed flag 416, resources of the preconfigured sidelink resources 444 including the preconfigured sidelink resource 446, and other sidelink resources. To illustrate, the processor 280x may select resources associated with the high speed flag 416 (such as a high speed frequency) based on the high speed flag 416 being asserted for the resources. In some examples, the first UE 115x may store the high speed flag 416 (or data associated with the high speed flag 416, such as data indicating the high speed frequency), and the processor 280x may read the data from the memory 282x.

In some other examples, the high speed flag 416 may be non-asserted for each resource of the sidelink resource pool 412. In some such examples, the processor 280x may access the value 452 indicated by the sidelink resource pool reselection timer 450 based on the high speed flag 416 being non-asserted. For example, the processor 280x may query the sidelink resource pool reselection timer 450 to determine the value 452. The processor 280x may compare the value 452 of the sidelink resource pool reselection timer 450 to the threshold value 448. Based on the value 452 of the sidelink resource pool reselection timer 450 failing to exceed the threshold value 448, the processor 280x may determine that the time interval 430 fails to exceed the threshold time interval 432 and may select the preconfigured sidelink resource 446 for the second sidelink transmission 472.

In some other examples, the high speed flag 416 may be non-asserted for each resource of the sidelink resource pool 412, and the value 452 of the sidelink resource pool reselection timer 450 may exceed the threshold value 448. In such examples, the processor 280x may determine that the time interval 430 exceeds the threshold time interval 432 and may initiate sidelink resource pool reselection. The processor 280x may select one or more sidelink resources for the second sidelink transmission 472, such as by selecting one or more resources of the sidelink resource pool 412 that are not associated with the high speed flag 416 (e.g., for which the high speed flag 416 is not asserted).

One or more aspects described herein may improve performance of a UE 115. For example, performance of the first UE 115x may be enhanced by enabling the first UE 115x to avoid one or more instances of sidelink resource pool reconfiguration. To illustrate, by reducing or avoiding sidelink resource pool reconfiguration, the UE may reduce power consumption associated with sidelink resource pool reconfiguration. Further, the first UE 115x may avoid data loss or latency that may occur due to inability of the first UE 115x to receive data, to transmit data, or both, during sidelink resource pool reconfiguration.

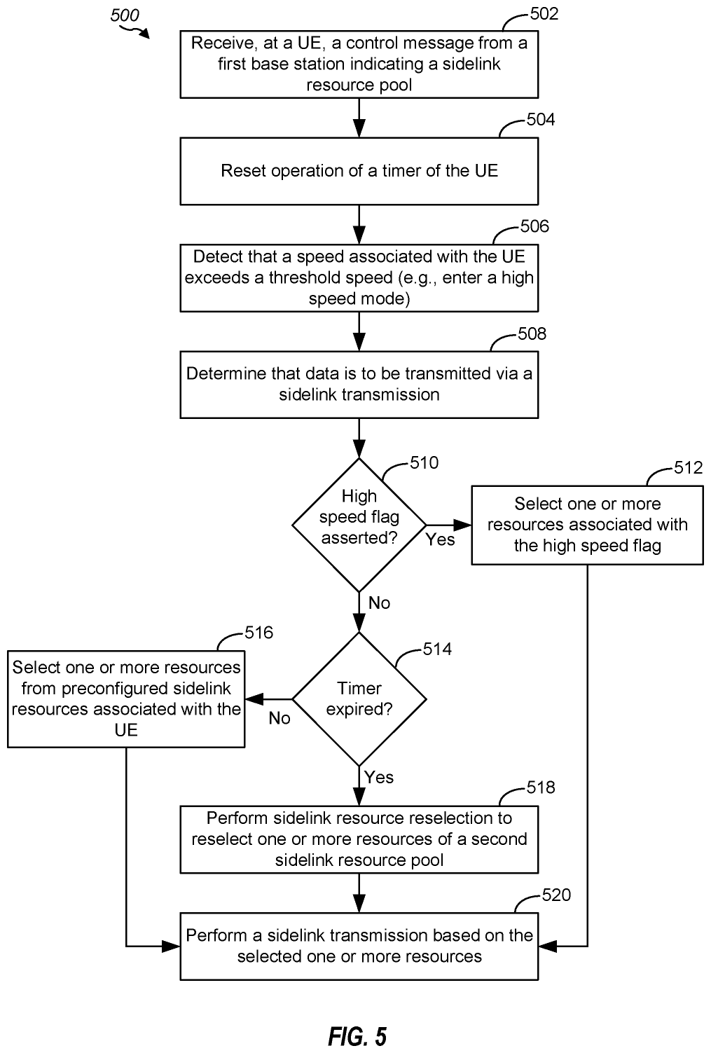

FIG. 6 is a flow chart illustrating an example of a method 600 of wireless communication performed by a UE according to some aspects of the disclosure. In some examples, the first UE 115x may perform the method 600. In some examples, the processor 280x is configured to initiate, perform, or control one or more operations of the method 600.

The method 600 includes receiving, from a base station, a control message indicating a sidelink resource pool, at 602. For example, the first UE 115x may receive the control message 410 from the base station 105, and the control message 410 may indicate the sidelink resource pool 412. In some examples, the receiver 458x is configured to receive the control message 410.

The method 600 further includes, after receiving the control message, performing a sidelink transmission using one or more sidelink resources, at 604. Based on a speed associated with the UE exceeding a threshold speed, the one or more sidelink resources include one of a first sidelink resource of the sidelink resource pool or a preconfigured sidelink resource. The one or more sidelink resources include the first sidelink resource based on the first sidelink resource being associated with a high speed flag. The one or more sidelink resources include the preconfigured sidelink resource based on a time interval since a previous sidelink transmission failing to exceed a threshold time interval and further based on the sidelink resource pool failing to indicate a resource associated with the high speed flag.

To illustrate, the first UE 115x may perform the sidelink transmission 150, the first sidelink transmission 470, or the second sidelink transmission 472 using the one or more sidelink resources based on the speed 442 of the first UE 115x exceeding a threshold speed. In some examples, the one or more sidelink resources may include the first sidelink resource 414 based on the first sidelink resource 414 being associated with the high speed flag 416 (e.g., as illustrated in the example of FIG. 4B). In some other examples, the one or more sidelink resources may include the preconfigured sidelink resource 446 based on the time interval 430 since a previous sidelink transmission (e.g., the sidelink transmission 150, the first sidelink transmission 470, or another sidelink transmission) failing to exceed the threshold time interval 432 and further based on the sidelink resource pool 412 failing to indicate a resource associated with the high speed flag 416. In some other examples, the one or more sidelink resources may include a second sidelink resource of the sidelink resource pool 412 (e.g., the second frequency F2 or the third frequency F3 of FIG. 4B) based on the time interval 430 exceeding the threshold time interval 432 and further based on the sidelink resource pool 412 failing to indicate the resource associated with the high speed flag 416 (e.g., where the sidelink resource pool 412 does not indicate the first sidelink resource 414, or where the first sidelink resource 414 is not associated with the high speed flag 416).

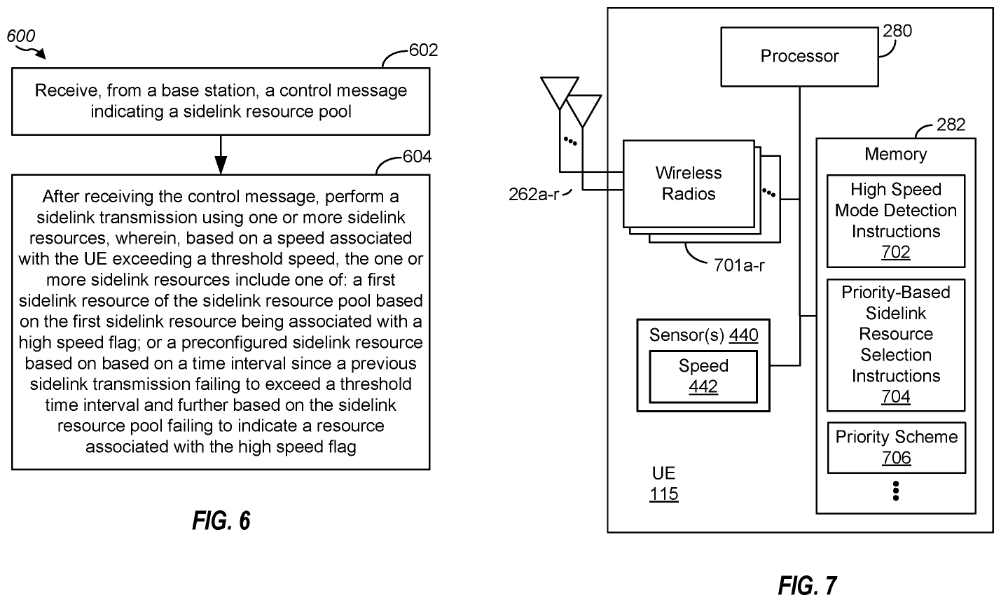

FIG. 7 is a block diagram illustrating an example of the UE 115 according to some aspects of the disclosure. The UE 115 of FIG. 7 may correspond to one or more UEs described herein, such as any of the UEs 115x, 115y, and 115z of FIG. 4A.

The UE 115 of FIG. 7 may include structure, hardware, or components illustrated in FIG. 2. For example, the UE 115 may include the processor 280, which may execute instructions stored in the memory 282. The UE 115 may also include the one or more sensors 440 of FIG. 4A.

Using the processor 280, the UE 115 may transmit and receive signals via wireless radios 701a-r and antennas 252a-r. The wireless radios 701a-r may include one or more components or devices described herein, such as the modulator/demodulators 254a-r, the MIMO detector 256, the receive processor 258, the transmit processor 264, the TX MIMO processor 266, the transmitter 356x, the receiver 358x, one or more other components or devices, or a combination thereof.

In some examples, the memory 282 may store instructions executable by one or more processors (e.g., the processor 280) to initiate, perform, or control one or more operations described herein. For example, the memory 282 may store high speed mode detection instructions 702 executable by the processor 280 to detect a high speed mode associated with the UE 115. To illustrate, the processor 280 may execute the high speed mode detection instructions 702 to receive data from the one or more sensors 440 (e.g., by querying the one or more sensors 440), and the data may indicate the speed 442. The processor 280 may execute the high speed mode detection instructions 702 to compare the speed 442 to a threshold speed. Based on the speed 442 exceeding the threshold speed, the processor 280 may detect that the UE 115 has entered a high speed mode.

Based on detecting the high speed mode, the UE 115 may perform a sidelink transmission (such as any of the sidelink transmissions 150, 470, and 472) using one or more sidelink resources. The UE 115 may execute priority-based sidelink resource selection instructions 704 to select the one or more sidelink resources. For example, the priority-based sidelink resource selection instructions 704 may indicate or may be associated with a priority scheme 706. The priority scheme 706 may indicate that a resource associated with the high speed flag 416 (e.g., the first sidelink resource 414 in the example of FIG. 4B) may be associated with a first priority (e.g., the first priority 492 of FIG. 4B) for the sidelink transmission and that the preconfigured sidelink resources 444 (e.g., the preconfigured sidelink resource 446) is associated with a second priority less than the first priority. The priority scheme 706 may also indicate that a second sidelink resource of the sidelink resource pool 412 not associated with the high speed flag 416 (e.g., the frequencies F2, F3 in the example of FIG. 4B) is associated with a third priority less than the second priority. In some implementations, the priority scheme 706 may correspond to the examples described with reference to the method 500 of FIG. 5.

In a first aspect, an apparatus for wireless communication by a UE includes a receiver configured to receive, from a base station, a control message indicating a sidelink resource pool. The apparatus further includes a transmitter configured to perform, after receiving the control message, a sidelink transmission using one or more sidelink resources. Based on a speed associated with the UE exceeding a threshold speed, the one or more sidelink resources include one of a first sidelink resource of the sidelink resource pool or a preconfigured sidelink resource. The one or more sidelink resources include the first sidelink resource based on the first sidelink resource being associated with a high speed flag. The one or more sidelink resources include the preconfigured sidelink resource based on a time interval since a previous sidelink transmission failing to exceed a threshold time interval and further based on the sidelink resource pool failing to indicate a resource associated with the high speed flag.

In a second aspect, in combination with the first aspect, the one or more sidelink resources include a second sidelink resource of the sidelink resource pool based on the time interval exceeding the threshold time interval and further based on the sidelink resource pool failing to indicate the resource associated with the high speed flag.

In a third aspect, in combination with one or more of the first aspect or the second aspect, the apparatus includes a processor configured to select the one or more sidelink resources for the sidelink transmission based on a priority scheme.

In a fourth aspect, in combination with one or more of the first aspect through the third aspect, the priority scheme indicates that the first sidelink resource is associated with a first priority for the sidelink transmission and that the preconfigured sidelink resource is associated with a second priority less than the first priority.

In a fifth aspect, in combination with one or more of the first aspect through the fourth aspect, the priority scheme further indicates that a second sidelink resource of the sidelink resource pool not associated with the high speed flag is associated with a third priority less than the second priority.

In a sixth aspect, in combination with one or more of the first aspect through the fifth aspect, the control message corresponds to a SIB.

In a seventh aspect, in combination with one or more of the first aspect through the sixth aspect, the control message corresponds to a RRC reconfiguration message.

In an eighth aspect, a method of wireless communication performed by a UE includes receiving, from a base station, a control message indicating a sidelink resource pool. The method further includes, after receiving the control message, performing a sidelink transmission using one or more sidelink resources. Based on a speed associated with the UE exceeding a threshold speed, the one or more sidelink resources include one of a first sidelink resource of the sidelink resource pool or a preconfigured sidelink resource. The one or more sidelink resources include the first sidelink resource based on the first sidelink resource being associated with a high speed flag. The one or more sidelink resources include the preconfigured sidelink resource based on a time interval since a previous sidelink transmission failing to exceed a threshold time interval and further based on the sidelink resource pool failing to indicate a resource associated with the high speed flag.

In a ninth aspect, in combination with the eighth aspect, the one or more sidelink resources include a second sidelink resource of the sidelink resource pool based on the time interval exceeding the threshold time interval and further based on the sidelink resource pool failing to indicate the resource associated with the high speed flag.

In a tenth aspect, in combination with one or more of the eighth aspect through the ninth aspect, further comprising selecting the one or more sidelink resources for the sidelink transmission based on a priority scheme.

In an eleventh aspect, in combination with one or more of the eighth aspect through the tenth aspect, the priority scheme indicates that the first sidelink resource is associated with a first priority for the sidelink transmission and that the preconfigured sidelink resource is associated with a second priority less than the first priority.

In a twelfth aspect, in combination with one or more of the eighth aspect through the eleventh aspect, the priority scheme further indicates that a second sidelink resource of the sidelink resource pool not associated with the high speed flag is associated with a third priority less than the second priority.

In a thirteenth aspect, in combination with one or more of the eighth aspect through the twelfth aspect, the control message corresponds to a SIB.

In a fourteenth aspect, in combination with one or more of the eighth aspect through the thirteenth aspect, the control message corresponds to a RRC reconfiguration message.

In a fifteenth aspect, a non-transitory computer-readable medium stores instructions executable by a processor to initiate, perform, or control operations of a UE. The operations include receiving, from a base station, a control message indicating a sidelink resource pool. The operations further include, after receiving the control message, performing a sidelink transmission using one or more sidelink resources. Based on a speed associated with the UE exceeding a threshold speed, the one or more sidelink resources include one of a first sidelink resource of the sidelink resource pool or a preconfigured sidelink resource. The one or more sidelink resources include the first sidelink resource based on the first sidelink resource being associated with a high speed flag. The one or more sidelink resources include the preconfigured sidelink resource based on a time interval since a previous sidelink transmission failing to exceed a threshold time interval and further based on the sidelink resource pool failing to indicate a resource associated with the high speed flag.

In a sixteenth aspect, in combination with the fifteenth aspect, the one or more sidelink resources include a second sidelink resource of the sidelink resource pool based on the time interval exceeding the threshold time interval and further based on the sidelink resource pool failing to indicate the resource associated with the high speed flag.

In a seventeenth aspect, in combination with one or more of the fifteenth aspect through the sixteenth aspect, the operations further include selecting the one or more sidelink resources for the sidelink transmission based on a priority scheme.

In an eighteenth aspect, in combination with one or more of the fifteenth aspect through the seventeenth aspect, the priority scheme indicates that the first sidelink resource is associated with a first priority for the sidelink transmission and that the preconfigured sidelink resource is associated with a second priority less than the first priority.

In a nineteenth aspect, in combination with one or more of the fifteenth aspect through the eighteenth aspect, the priority scheme further indicates that a second sidelink resource of the sidelink resource pool not associated with the high speed flag is associated with a third priority less than the second priority.

In a twentieth aspect, in combination with one or more of the fifteenth aspect through the nineteenth aspect, the control message corresponds to one of a SIB or a RRC reconfiguration message.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein may include one or more processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language, or otherwise. In addition, one or more features discussed herein may be implemented via specialized processor circuitry, via executable instructions, or combinations thereof.

One or more illustrative logics, logical blocks, modules, circuits, and processes described herein may be implemented as electronic hardware, computer software, or combinations of both. Features may be described generally, in terms of functionality, and illustrated in the various illustrative components, blocks, modules, circuits, and processes described herein. Whether such functionality is implemented in hardware or software may depend upon the particular application and design of the overall system.

A hardware and data processing apparatus used to implement the various illustrative logics, logical blocks, modules and circuits described in connection with one or more aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof, designed to perform one or more functions described herein. A general purpose processor may be a microprocessor, or any processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In some aspects, one or more functions described herein may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, a function may be stored on or transmitted over as one or more instructions or code on a computer-readable medium. The operations of a method or process disclosed herein may be implemented in a processor-executable software module which may reside on a computer-readable medium. Computer-readable media includes computer storage media. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or process may reside as one or any combination or set of codes and instructions on a machine readable medium and computer-readable medium, which may be incorporated into a computer program product.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

What is claimed is:

1. An apparatus for wireless communication by a user equipment (UE), the apparatus comprising:
a receiver configured to receive, from a base station, a control message indicating a sidelink resource pool; and
a transmitter configured to perform, after receiving the control message, a sidelink transmission using one or more sidelink resources, wherein, based on a speed associated with the UE exceeding a threshold speed, the one or more sidelink resources include one of:
a first sidelink resource of the sidelink resource pool based on the first sidelink resource being associated with a high speed flag; or a preconfigured sidelink resource based on based on a time interval since
a previous sidelink transmission failing to exceed a threshold time interval and further based on the sidelink resource pool failing to indicate a resource associated with the high speed flag.

2. The apparatus of claim 1, wherein the one or more sidelink resources include a second sidelink resource of the sidelink resource pool based on the time interval exceeding the threshold time interval and further based on the sidelink resource pool failing to indicate the resource associated with the high speed flag.

3. The apparatus of claim 1, further comprising a processor configured to select the one or more sidelink resources for the sidelink transmission based on a priority scheme.

4. The apparatus of claim 3, wherein the priority scheme indicates that the first sidelink resource is associated with a first priority for the sidelink transmission and that the preconfigured sidelink resource is associated with a second priority less than the first priority.

5. The apparatus of claim 4, wherein the priority scheme further indicates that a second sidelink resource of the sidelink resource pool not associated with the high speed flag is associated with a third priority less than the second priority.

6. The apparatus of claim 1, wherein the control message corresponds to a system information block (SIB).

7. The apparatus of claim 1, wherein the control message corresponds to a radio resource control (RRC) reconfiguration message.

8. A method of wireless communication performed by a user equipment (UE), the method comprising:
receiving, from a base station, a control message indicating a sidelink resource pool; and
after receiving the control message, performing a sidelink transmission using one or more sidelink resources, wherein, based on a speed associated with the UE exceeding a threshold speed, the one or more sidelink resources include one of:
a first sidelink resource of the sidelink resource pool based on the first sidelink resource being associated with a high speed flag; or
a preconfigured sidelink resource based on based on a time interval since a previous sidelink transmission failing to exceed a threshold time interval and further based on the sidelink resource pool failing to indicate a resource associated with the high speed flag.

9. The method of claim 8, wherein the one or more sidelink resources include a second sidelink resource of the sidelink resource pool based on the time interval exceeding the threshold time interval and further based on the sidelink resource pool failing to indicate the resource associated with the high speed flag.

10. The method of claim 8, further comprising selecting the one or more sidelink resources for the sidelink transmission based on a priority scheme.

11. The method of claim 10, wherein the priority scheme indicates that the first sidelink resource is associated with a first priority for the sidelink transmission and that the preconfigured sidelink resource is associated with a second priority less than the first priority.

12. The method of claim 11, wherein the priority scheme further indicates that a second sidelink resource of the sidelink resource pool not associated with the high speed flag is associated with a third priority less than the second priority.

13. The method of claim 8, wherein the control message corresponds to a system information block (SIB).

14. The method of claim 8, wherein the control message corresponds to a radio resource control (RRC) reconfiguration message.

15. A non-transitory computer-readable medium storing instructions executable by a processor to initiate, perform, or control operations of a user equipment (UE), the operations comprising:
receiving, from a base station, a control message indicating a sidelink resource pool; and
after receiving the control message, performing a sidelink transmission using one or more sidelink resources, wherein, based on a speed associated with the UE exceeding a threshold speed, the one or more sidelink resources include one of:
a first sidelink resource of the sidelink resource pool based on the first sidelink resource being associated with a high speed flag; or
a preconfigured sidelink resource based on based on a time interval since a previous sidelink transmission failing to exceed a threshold time interval and further based on the sidelink resource pool failing to indicate a resource associated with the high speed flag.

16. The non-transitory computer-readable medium of claim 15, wherein the one or more sidelink resources include a second sidelink resource of the sidelink resource pool based on the time interval exceeding the threshold time interval and further based on the sidelink resource pool failing to indicate the resource associated with the high speed flag.

17. The non-transitory computer-readable medium of claim 15, wherein operations further include selecting the one or more sidelink resources for the sidelink transmission based on a priority scheme.

18. The non-transitory computer-readable medium of claim 17, wherein the priority scheme indicates that the first sidelink resource is associated with a first priority for the sidelink transmission and that the preconfigured sidelink resource is associated with a second priority less than the first priority.

19. The non-transitory computer-readable medium of claim 18, wherein the priority scheme further indicates that a second sidelink resource of the sidelink resource pool not associated with the high speed flag is associated with a third priority less than the second priority.

20. The non-transitory computer-readable medium of claim 15, wherein the control message corresponds to one of a system information block (SIB) or a radio resource control (RRC) reconfiguration message.
